(19) United States
(12) Patent Application Publication
(10) Pub. No.: US 2025/0201006 A1
(43) Pub. Date: Jun. 19, 2025

(54) Generating Optimized Datasets for Training Machine-Learned Models for Subjective Image Understanding

(71) Applicant: Google LLC, Mountain View, CA (US)

(72) Inventors: Lenord Melvix Joseph Stephen Max, Mountain View, CA (US); Alexandra Felicia Vallis, New York, NY (US); Huy Thong Nguyen, Mountain View, CA (US); En-Hung Chu, Mountain View, CA (US); Canwen Jiao, Menlo Park, CA (US); Anusha Reddy Kommidi, Hyderabad (IN); Benjamin John Louie, Newark, CA (US)

(21) Appl. No.: 18/439,462

(22) Filed: Feb. 12, 2024

(30) Foreign Application Priority Data
Dec. 14, 2023 (IN) 202311085516

(51) Int. Cl. G06V 20/70; G06V 10/764; G06V 10/774; G06V 10/776

(52) U.S. Cl. CPC G06V 20/70; G06V 10/764; G06V 10/774; G06V 10/776

(57) ABSTRACT

The present disclosure provides computer-implemented methods, systems, and devices for analyzing visual content to assign one or more subjective labels. A computing device transmits a piece of visual content and a subjective attribute to a plurality of computing systems. The computing system receives operator feedback indicative of ratings from the operators, each rating indicative of a perceived similarity between the visual content and the subjective attribute. The computing system determines that a similarity between the ratings is less than a threshold similarity. Responsive to determining that a similarity between the ratings is less than a threshold similarity, the computing system generates pseudo-labels associated with the subjective attribute, wherein the one or more pseudo-labels comprise additional description of the subjective attribute. The computing system transmits the one or more pseudo-labels and a piece of visual content to a second plurality of computing systems.

### FIELD

The present disclosure relates generally to analyzing visual content. More particularly, the present disclosure relates to a system for generating labels for subjective attributes for visual content.

### BACKGROUND

As computing devices have improved, they can be used to provide an increasing number of services to users. In some examples, computing devices can be used to capture and display images. Images can be used to convey information to users. One specific example is location-based searching. Each location can have one or more images. The images can be analyzed to determine one or more attributes of a location for responding to a user query. However, some queries can involve subjective attributes that are difficult to determine based on images. In addition, subjective attributes can be subject to bias based on cultural factors or stereotypes. It would be useful if a computing system (or an application thereon) could accurately determine subjective characteristics of images and use that information to respond to users' queries more effectively.

### SUMMARY

Aspects and advantages of embodiments of the present disclosure will be set forth in part in the following description, or can be learned from the description, or can be learned through practice of the embodiments.

One example aspect of the present disclosure is directed at a computing system. The system can include one or more processors and one or more non-transitory computer-readable media that collectively store instructions that, when executed by the one or more processors, cause the computing system to perform operations. The operations can include transmitting a piece of visual content and a subjective attribute to a first plurality of computing systems respectively associated with a plurality of operators. The operations can further include receiving first operator feedback information indicative of a first plurality of ratings from the plurality of operators, wherein each of the plurality of ratings are indicative of a perceived similarity between the piece of visual content and the subjective attribute. The operations can further include determining that a similarity between each of the first plurality of ratings is less than a consensus threshold similarity. The operations can further include responsive to determining that a similarity between each of the plurality of ratings is less than a consensus threshold similarity, generating one or more pseudo-labels associated with the subjective attribute, wherein the one or more pseudo-labels comprise additional description of the subjective attribute. The operations can further include transmitting the one or more pseudo-labels and the piece of visual content to a second plurality of computing systems respectively associated with a plurality of trained users.

Another example aspect of the present disclosure is directed to the computer-implemented method. The method comprises transmitting a piece of visual content and a subjective attribute to a first plurality of computing systems respectively associated with a plurality of operators. The method further comprises receiving first operator feedback information indicative of a first plurality of ratings from the plurality of operators, wherein each of the plurality of ratings are indicative of a perceived similarity between the piece of visual content and the subjective attribute. The method further comprises determining that a similarity between each of the first plurality of ratings is less than a consensus threshold similarity. The method further comprises responsive to determining that a similarity between each of the plurality of ratings is less than a consensus threshold similarity, generating one or more pseudo-labels associated with the subjective attribute, wherein the one or more pseudo-labels comprise additional description of the subjective attribute. The method further comprises transmitting the one or more pseudo-labels and the piece of visual content to a second plurality of computing systems respectively associated with a plurality of trained users.

Another example aspect of the present disclosure is directed to one or more non-transitory computer-readable media that collectively store instructions that, when executed by one or more computing devices, cause the one or more computing devices to perform operations. The operations can include transmitting a piece of visual content and a subjective attribute to a first plurality of computing systems respectively associated with a plurality of operators. The operations can further include receiving first operator feedback information indicative of a first plurality of ratings from the plurality of operators, wherein each of the plurality of ratings are indicative of a perceived similarity between the piece of visual content and the subjective attribute. The operations can further include determining that a similarity between each of the first plurality of ratings is less than a consensus threshold similarity. The operations can further include responsive to determining that a similarity between each of the plurality of ratings is less than a consensus threshold similarity, generating one or more pseudo-labels associated with the subjective attribute, wherein the one or more pseudo-labels comprise additional description of the subjective attribute. The operations can further include transmitting the one or more pseudo-labels and the piece of visual content to a second plurality of computing systems respectively associated with a plurality of trained users.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing system that uses machine-learned models to respond to user requests with respect to text extracted from an image according to example embodiments of the present disclosure;

FIG. 2 illustrates an example of objective attributes and subjective attributes according to some embodiments of the present disclosure.

FIG. 3 illustrates an example of rating categories for a particular subjective attribute according to some embodiments of the present disclosure.

FIG. 4 illustrates an example flow for identified subjective attributes (topics) to be used as labels for visual content according to some embodiments of the present disclosure.

FIG. 5 illustrates an example of ratings produced by large language models and how those ratings are interpreted according to some embodiments of the present disclosure.

FIG. 6 illustrates an example of ratings produced by large language models according to some embodiments of the present disclosure.

FIG. 7 illustrates examples of methods of using labeled data to train machine-learned models according to some embodiments of the present disclosure.

FIG. 8 illustrates an example method for improving the efficiency of labeling rare topics according to some embodiments of the present disclosure.

FIG. 9 illustrates an example method for improving the accuracy of the golden data set generation system according to some embodiments of the present disclosure.

FIG. 10 depicts a block diagram of a visual content labeling system that performs according to example embodiments of the present disclosure.

FIG. 11 depicts a block diagram of an example computing device that performs according to example embodiments of the present disclosure.

FIG. 12 depicts a block diagram of an example computing device that performs according to example embodiments of the present disclosure.

FIG. 13 depicts an example flow diagram for a method of accurately providing labels for visual content according to example embodiments of the present disclosure.

Reference numerals that are repeated across plural figures are intended to identify the same features in various implementations.

### DETAILED DESCRIPTION

Generally, the present disclosure is directed to systems and methods for analyzing visual content (images and videos) to assign one or more labels to the visual content. In particular, the systems and methods disclosed herein can leverage visual content processing techniques and machine-learned models to provide analysis and additional content for images and videos associated with locations. For example, the systems and methods disclosed herein can be utilized to request ratings from a rating user (also referred to as an operator), evaluate those ratings, and provide highly accurate labels for subjective attributes for images and videos.

In some examples, content classifiers can accurately and quickly provide labels for objective factors associated with images and videos. For example, an image classifier can accurately determine whether a cat is present in an image. However, with various subjective attributes, current classifiers fail to generate labels that accurately represent the subjective attributes. To accurately generate labels for subjective attributes, a visual content labeling system can employ rating users (operators) to create or select initial ratings for particular subjective attributes with respect to one or more images and videos, evaluate those ratings for consensus and bias, and improve the likelihood that labeling is accurately performed.

In some examples, a visual content labeling system can determine a list of subjective attributes of interest. The visual content labeling system can generate labels for a plurality of images and videos for each subjective attribute of interest. The visual content labeling system can transmit rating data to the computing systems of one or more rating users or operators. The rating data can include one or more images or videos to be rated, the subjective attribute of interest, and one or more rating categories the rating users may select. The rating categories can include, but not limited to, categories such as “highly applicable” to the image or video to “not applicable” to the image or video. For each image or video, each rating user can select a particular rating category for a respective subjective attribute and return those ratings to a visual content labeling system. In some examples, the user can select a rating score and the visual content labeling system can determine the specific rating category for the rating score.

The visual content labeling system can determine whether the labels generated by the plurality of operators reach a consensus. For example, determining whether a consensus has been reached can be based on the degree to which the ratings from the plurality of operators match. For example, if there are five potential rating categories, the visual content labeling system can determine whether a threshold percentage of the ratings select the same rating category (e.g., “highly relevant,” “highly non-relevant,” “neutral,” and so on). If the threshold percentage is 90%, the visual content labeling system can determine whether any of the five ratings receive at least 90% of the ratings from the operators. The visual content labeling system can store a label associated with the selected rating if a consensus is determined to be reached. If no consensus is determined to have been reached, the visual content labeling system can perform operations to improve the potential for consensus between the rating users. In some examples, the visual content labeling system can alter the subjective attribute or generate a pseudo-label. A pseudo-label can describe the subjective attribute in terms more useful for an operator when selecting a rating. In some examples, a pseudo-label can include one or more objective attributes or concepts that can be used to understand the subjective attribute more clearly.

For example, if the original subjective attribute is “family-friendly”, a pseudo-label can be “is appropriate for children” or “has accommodation for families.” The pseudo-labels can be transmitted to a second group of operators, and the second group of operators can select new ratings. In some examples, the second group of operators can differ from the original group of operators. The second group of operators can return their ratings to the labeling system, and the visual content labeling system can determine whether consensus has been reached in the recently received ratings. If no consensus is determined to be reached, the visual content labeling system can use crowdsource labeling systems to determine the appropriate label for an image.

For example, the visual content labeling system can select a random sampling of users from a list of all potential users who can provide ratings and transmit the image in question, the subjective attribute, and the pseudo-labels to the selected users for additional ratings. These randomly selected users can return their ratings to the visual content labeling system which can check again for consensus. If no consensus is determined to be reached, the system can use machine-learned models to generate potential labels for the image.

In one example, the system determines whether each image in a plurality of images is associated with the subjective attribute “cozy.” Initially, the system can transmit the set of images and the subjective attribute “cozy” to a plurality of operators (or rating users). For a particular image, the visual content labeling system can receive a plurality of ratings. The ratings can be compared to determine whether a sufficient number of the rating users have selected the same rating to meet the consensus threshold. If not, the system can generate one or more pseudo-labels associated with the subjective attribute “cozy.” For example, appropriate pseudo-labels can include “warm lighting,” “a fireplace,” and “seats close together.” Pseudo labels can be sent to a second plurality of rating users (operators) with the plurality of images for which no consensus has yet been reached. The rating users can again select a rating category representing the degree to which the pseudo-labels match the image or video. The visual content labeling system can select one or more users within a demographically diverse community to provide ratings if no consensus is reached. Based on these steps, images or videos rated as highly relevant to the subjective attribute “cozy” can receive the label “cozy.” In contrast, while locations rated as not relevant to the subjective attribute “cozy” will not receive the label “cozy.” The labeling data can be stored in a database associated with each of the images or videos.

More specifically, a server computing system can provide a visual content labeling system. A server computing system can be any computing system configured to communicate with a user computing device (or other computing devices) over a network to provide information or a service. If a server computing system is employed, the server computing system can transmit requests for ratings, images, subjective attributes, and any other necessary information to a plurality of computing systems associated with a third group of rating users. The server computing system can receive, from a user computing device, ratings provided by the users based on requests from the visual content labeling system.

A user computing device can be any computing device designed to be operated by an end-user. For example, a user computing device can include but is not limited to a personal computer, a smartphone, a smartwatch, a tablet computer, a laptop computer, a hand-held navigation computing device, a wearable computing device, a game console, and so on. In some examples, a user computing device can include a display that can display images, videos, subjective attributes, and a plurality of rating categories. In addition, the user computing device can also include an input device (e.g., a mouse, a keyboard, an audio input device, and so on) to enable a user to provide ratings for the subjective attribute.

When analyzing images to determine labels, certain types of attributes, called objective attributes, can be easily determined at a high accuracy rate. For example, if the attribute is “cat,” modern machine-learned models can be trained to determine whether a cat is present in the image. However, another group of attributes are much more difficult for machine-learned models to identify accurately. These attributes can be subjective attributes. Examples of subjective attributes can include “family-friendly,” “good atmosphere,” “fun,” or more specific descriptive attributes like “a lazy river.” These attributes cannot be confidently identified based on the presence of a single attribute.

In some examples, accurately labeling images based on subjective attributes can be important for responding to user requests or identifying the content of an image or a video. A visual content labeling system may access or generate a list of potential subjective attributes that may apply to images or videos. In some examples, the subjective attributes can be discarded for being controversial, associated with particular types of bias, or not related to the interests of the visual content labeling system. For example, suppose the visual content labeling system generates labels for images associated with locations. In this case, the visual content labeling system may focus on labels associated with the attributes of locations and discard subjective attribute labels not associated with locations.

In some examples, the query response system can receive a user location query that seeks information about one or more locations. Some queries can be associated with subjective attributes of locations. The search response system can access a database of locations to identify acceptable locations. Each location can have a plurality of images and videos that are associated with that location. For example, users can submit images of particular locations to a centralized system. A labeling system can be used to generate labels for each image and/or video. Some of the labels can be objective attribute labels, and some of the labels can be subjective attribute labels. The query response system can use the labels associated with images for a particular location to determine whether the location is associated with a specific query. In some examples, the query response system can select the locations based on stored data about the locations. The query response system can select the particular images used to represent the location based on the subjective attribute labels associated with the location.

To generate these labels, a visual content labeling system can use a process to quickly and efficiently evaluate ratings received to eliminate bias and build consensus. This process begins with identifying the specific subjective attributes for which the images and videos should be labeled. For example, if the visual content labeling system has access to a list of subjective attributes that are to be used to label visual content, a subjective attribute from that list can be accessed. The visual content labeling system can then determine a plurality of images and videos to be evaluated. The visual content labeling system can also determine a list of rating users to provide initial ratings for the images and/or videos.

The labeling system can transmit the selected subjective attribute and visual content (e.g., images, videos, and so on) to a plurality of rating users via a communication network. User computer devices can display the images/videos and the subjective attribute to the rating users for evaluation. In some examples, an application on the user computing device displays the image and the subjective attribute. Each subjective attribute can have a plurality of rating categories that can represent the degree to which the subjective attribute applies to the image. In one specific example, a rating can have five potential rating categories. For example, the rating categories can be completely related (5), somewhat related (4), neither related or unrelated (3), somewhat unrelated (2), or completely unrelated (1).

In some examples, the rating users (operators) can select the rating category that applies to the image based on the subjective attribute. A plurality of ratings from different rating operators can be returned to the visual content labeling system. Based on the received ratings, the visual content labeling system can then determine whether there is a consensus among the rating users.

In some examples, consensus can be determined to exist based on the similarity of the ratings received from the rating users. For example, the visual content labeling system can determine a threshold at which consensus is determined to have been reached. The visual content labeling system can determine how many ratings are in each category of the potential rating categories. If, for example, all of the ratings have the same rating category, then the similarity percentage is 100% and consensus is determined to be found. However, the threshold can be less than 100%. For example, if 90% of all the ratings fall within the same particular rating category, the visual content labeling system can determine that the ratings meet the threshold for consensus. In some examples, the predetermined consensus threshold can be determined by each visual content labeling system or for each subjective attribute category.

If consensus around a particular label category is determined to be reached, the visual content labeling system can apply that label to the image and store that information for future use. However, if there is no consensus about a particular label, the visual content labeling system can access rating guidelines for the specific subjective attribute. The rating guidelines can be pre-established by experts or generated by a machine-learned model based on previous examples and the current subjective attribute.

The visual content labeling system can transmit the image, the subjective attribute, and the rating guidelines to a second plurality of rating users or operators. In some examples, the second plurality of rating users or operators can include one or more users or operators from the first plurality of rating users. In other examples, the second plurality of rating users is entirely distinct from the first plurality of rating users. As with the first plurality of rating users, the second plurality of rating users can select a particular rating category and transmit that rating back to the labeling system.

When the ratings have been received, the visual content labeling system can again check for consensus, as seen above. If consensus is reached, labels associated with the consensus rating category are associated with the images (or videos) and the labels and images are stored for later user. If no consensus is reached, the visual content labeling system can automatically take steps to improve the likelihood of reaching a consensus.

One method for improving the likelihood of reaching a consensus is to generate pseudo-labels. Pseudo-labels can be alternative ways of referring to a particular subjective attribute. For example, pseudo-labels can include more detail, be more descriptive, or include the description of particular components associated with the subjective attribute. For example, if the subjective attribute is romantic, the pseudo-labels can include “interior,” “candlelight,” “couples,” “wine,” “booth seating,” and so on. Similarly, if the studio label is family-friendly the pseudo-label can include “adults and kids without couples and without a bar.” The pseudo-labels can provide additional information for the rating users to enable them to determine whether a particular image is associated with the subjective attribute.

In some examples, the pseudo-labels can be generated automatically by a large language model based on the prompt that includes the subjective attribute and a request for more descriptive terms associated with the subjective attribute. In another example, the subjective attributes can be accessed from a list of expert-generated pseudo-labels.

Once the pseudo-labels have been accessed, the labeling system can transmit the images, the subjective attribute, and one or more pseudo-labels to a third set of rating users. In some examples, the users and the third set of users may include users from the first and second set of rating users. In other examples, the third set of users may only include users or operators not included in the first cloud or second plurality of rating users.

The labeling system can receive user ratings from a third plurality of users. As mentioned above, the labeling system can determine whether there is consensus in the ratings. If there is a consensus reached, the images (and videos) can be labeled with the rating category around which consensus was reached. The labels and the associated pieces of visual content can be stored in a database for later retrieval. If no consensus is reached, the labeling system can use crowdsourcing another time to reach a consensus.

The crowdsourcing method can include identifying a large pool of potential readers willing to provide ratings but not part of the formal rating program. These users can be from diverse backgrounds and diverse geographic locations. Having a diverse group of users is important to avoid bias in the ratings. The labeling system can transmit the images (and videos) and the subjective attribute (and potentially the pseudo-label) to a fourth plurality of users (e.g., the crowdsourced users).

The labeling system can receive the ratings from the crowdsourced users and determine whether a consensus has been reached. In some examples, the threshold for rating consensus for ratings received through crowdsourcing may be a lower threshold than for ratings generated by trained rating users. If consensus is reached, a label is generated based on the rating category that met the consensus threshold (the rating category selected by 90% of the ratings, if the threshold is 90%). The generated label can be associated with the image (or video) this data can be stored in the database. Some examples, if no consensus is reached in any of the steps, the image can be labeled as unlabeled and discarded from future consideration for the particular subjective attribute.

Once a plurality of images have been labeled for each subjective attribute in the list of subjective attributes, the visual content (and any associated labels) can be stored in a database. This group of images, videos, and labels associated with subjective attributes can be referred to as a golden data set due to the high accuracy of the labels generated based on this system. This golden set can be used as ground truth data in training a labeling model.

Another way to access or generate training data can be to use multiple large language models to generate ratings and confidence values. For example, the labeling system can generate input for a plurality of different large language models. Each large language model can be trained separately and have different internal weights and values. The input for each model can be customized such that it is correctly formatted for the particular large language model for which it is intended. For example, the input can include one or more images to be rated, the subjective attribute to be rated, and a prompt requesting a rating for each image or video.

Each LLM can output a rating for each image. The rating can include the specific rating category that the LLM associated with the image (e.g., a rating category from “highly relevant” to “highly nonrelevant”) and a confidence value associated with the rating. The plurality of ratings from the different large language models can be compared to determine whether they reach a consensus on the rating category. For example, this consensus can be based on the agreement between the different writings and slash or the agreement between the confidence of the various rating categories. Thus, if all the ratings have the same rating category, but the confidence is low from the different large language models, the system may determine that the consensus has not been reached. Conversely, if not all of the ratings match but the ratings that do match all have a very high confidence without only a few outliers that have low confidence, the system may determine that a consensus has been reached.

All images or videos that have received labels based on a consensus of the multiple large language models can be stored as training data. This training data can be used to train a visual content labeling model that generates labels for images and videos based, at least in part, on subjective attributes. In some examples, this initial training data can be used to train a machine-learning model and the golden data set or human-labeled images described above can be used to validate or improve the model.

In some examples, particular subjective attributes are very rare. For example, very few images meet the qualifications to be classified as romantic. As a result, using human raters to sort through thousands of images when only a few of those images will match the qualifications is highly inefficient. One way to improve this effectiveness is to use multiple large language models to generate ratings from a large corpus of images and videos automatically. Based on these initial ratings, the visual content labeling system can identify a subset of the large corpus of images that reach a threshold of being associated with a romantic label.

Once this smaller subset of images has been identified, the labeling system can use the human labeling system described above to determine which of remaining images and videos are associated with the subject attribute.

The systems and methods of the present disclosure provide a number of technical effects and benefits. As one example, the system and methods can provide increased accuracy in labeling visual content. In particular, the systems and methods disclosed herein can automatically response to a lack of consensus in ratings. A technical benefit of the systems and methods of the present disclosure is the ability to automatically adjust rating policies, generate pseudo labels, and access crowdsourcing resources when consensus has not been reached. Doing so results in improved accuracy in labeling the visual content and therefore, improvements in the functioning of a computing system.

The proposed system solves the technical problem of how to effectively determine whether a particular image or video is associated with one or more subjective attributes, and subsequently provide relevant and appropriate services or actions in response to user requests. In particular, the system uses consensus determination techniques and machine-learned models to automatically reduce bias and improve reliability. These techniques are technical in nature, as they involve specific algorithms, computations, and operations on the data. These operations involve processing and transforming data in a way that achieves a concrete and tangible result. For example, the system may provide a generate a large corpus of labeled visual content, use that labeled content to train a machine-learned model, and provide services for queries associated with subjective attributes, such as selecting an image associated with a particular subjective attribute for displaying to a user in response to a location query, which are meaningful outputs that serve a practical purpose. Moreover, the system's ability to automatically generate pseudo-labels, check for user bias, and iterate until a consensus is reached without human intervention further demonstrate its technical nature. These features involve specific hardware configurations and software instructions that are necessary to implement the system.

With reference now to the Figures, example embodiments of the present disclosure will be discussed in further detail.

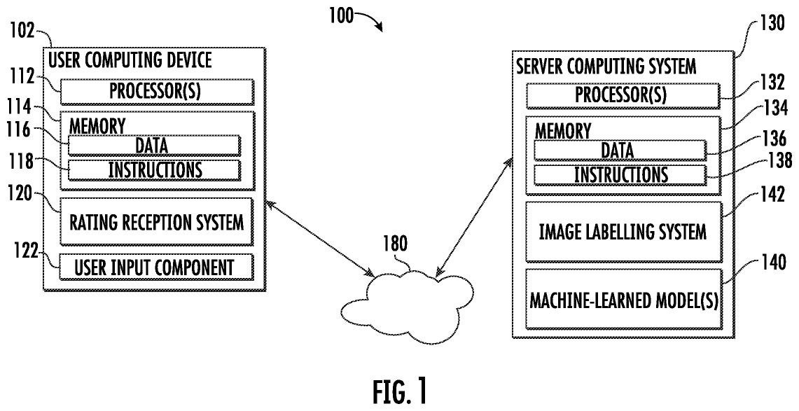

FIG. 1 depicts a block diagram of an example computing system 100 that uses machine-learned models to respond to user requests with respect to text extracted from an image according to example embodiments of the present disclosure. The computing system 100 includes a user computing device 102, and a server computing system 130 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can include a rating reception system 120 to allow users to rate images and videos according to a subjective attribute and submit the ratings to the server computing system 130. In some examples, the rating reception system 120 can be configured to receive from the server computing system 130, one or more images and videos, a subjective attribute, and potentially, one or more pseudo-labels for the subjective attribute. The rating reception system 120 can display each image to the user along with an interface for inputting a rating for the image in light of the subjective attribute.

The interface can include a list of rating categories available for rating the image concerning the subjective attribute. For example, the available rating categories can include “highly relevant,” “somewhat relevant,” “neutral,” “somewhat irrelevant,” and “highly irrelevant.” The user can employ a user input component 122 to select a particular rating category for the image or video from a list of rating categories. The user computing device 102 can also include one or more user input components 122 that receive user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, a mouse, or other means by which a user can provide user input. The rating reception system 120 can transmit any rating data received from the user (e.g., one rating for each image in a plurality of images) to the server computing system 130.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140 and a visual content labeling system 142. For example, the machine-learned models 140 can be or can otherwise include various machine-learned models. Example machine-learned models include neural networks or other multi-layer non-linear models. Example neural networks include large language models, feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The network 180 can be any type of communications network, such as a local area network (e.g., intranet), wide area network (e.g., Internet), or some combination thereof, and can include any number of wired or wireless links. In general, communication over the network 180 can be carried via any wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

The visual content labeling system 142 can determine that a plurality of images or videos associated with locations are to be labeled based on one or more subjective attributes. The visual content labeling system 142 can select a particular subjective attribute and one or more images or videos to be labeled. The server computing system 130 can transmit the image and the subjective attribute to the user computing device 102. The visual content labeling system 142 can receive from the user computing device 102, rating data for each of the transmitted images or videos for the respective subjective attribute.

For each image, the visual content labeling system 4 to 142 can receive a plurality of ratings from different users. The visual content labeling system 142 can determine whether the rating users have reached a consensus with their ratings. For each rating, the rating information can include a particular rating category that the user has selected for the image or video with respect to the subjective attribute. For example, users can select the rating category highly relevant, indicating that the image is relevant to the subjective attribute and should be labeled with that subjective attribute for future use. Other rating categories can be selected.

The visual content labeling system 142 can determine that a consensus has been reached with respect to a particular image when the amount of agreement between the rating users exceeds a threshold value. The threshold value can be predetermined or determined on a case-by-case basis based on the subjective attribute and the characteristics of the images and/or videos. In some examples, consensus is only determined to be reached when all the rating users select the same rating category for the image. In other examples, consensus can be reached if a certain percentage of all the users have the same rating. For example, if the threshold is 85%, the visual content labeling system 142 can determine that the consensus has been reached if at least 85% of the ratings received select the same rating category.

Once consensus has been reached, the visual content labeling system 142 can attach a label indicating the consensus rating category. For example, if the consensus rating category is “highly relevant,” the label can indicate that the image is associated with this subject attribute. Similarly, if the consensus rating is “highly non-relevant,” the label can indicate that the image is not associated with the subjective attribute. This data can be stored for later use when selecting images associated with a particular subjective attribute.

In accordance with a determination that a consensus has not been reached, the visual content labeling system 142 can access policy instructions or documents for rating images based on the subjective attribute. This policy data can be generated by experts or generated automatically by large language models based on prompts requesting such policies. The visual content labeling system 142 can send the images, the subjective attribute, and the access rating policies to a second plurality of rating users or operators. The second plurality of rating users can include one or more users from the first plurality or be entirely separate from the first plurality of rating users.

The visual content labeling system 142 can receive, from the second plurality of rating users, a plurality of ratings for one of our images and the subjective attribute. As discussed above, the visual content labeling system 142 can determine whether the ratings have reached a consensus. If so, the ratings can be stored as labels for each image or video. If no consensus has been reached for the ratings, the visual content labeling system can generate pseudo-labels for the subjective attribute.

As discussed above, pseudo-labels can be an alternative description of the subjective attribute. The alternative description can include additional details. The additional details can provide more specific factors to evaluate when the rating users rate an image. For example, if the subjective attribute is “romantic,” the pseudo-labels can include the words interior, candlelight, couples, wine, booth seating, and so on. Similarly, if the studio label is family-friendly the pseudo-label can include “adults and kids” and “without couples” and “without a bar”. The pseudo-labels can provide additional information for the raters to enable them to determine whether a particular image is associated with the subjective attribute.

The visual content labeling system can transmit the images, the subjective attribute, and the pseudo-label to a third plurality of rating users. As noted above, the rating users can be referred to as operators and one or more of the third plurality of rating users may be included in the first plurality of rating users and the second plurality of rating users. The third plurality of rating users can provide ratings for the one or more images and videos based on the subjective attribute and the one or more pseudo-labels. The visual content labeling system 142 can receive ratings from the users.

The visual content labeling system 142 can determine whether the received ratings form a consensus. As mentioned above, if a consensus is formed, the rating category around which the consensus is formed can be added to the image as a label, and this data can be stored for later use. If no consensus is formed, the visual content labeling system 142 can attempt to use crowdsourcing to develop a consensus. For example, the visual content labeling system 142 can select a plurality of users such that they are diverse in order to remove bias. These users can be from a general pool of users who are willing to provide ratings but are not generally tasked with providing ratings. The visual content labeling system 142 can transmit one more image for which no consensus has been reached, the subjective attribute, the pseudo-labels, and potentially the rating guidelines or policies for the subjective attribute.

The crowdsourced users (e.g., a fourth plurality of users) can rate the images and videos based on the subjective attribute, the pseudo-labels, and any guidelines for rating the visual content. The crowdsourced users can return the ratings back to the visual content labeling system. Based on those ratings, the visual content labeling system 142 can determine whether a consensus has been reached for a particular rating category. If so, as above, the visual content labeling system 142 can store a label associated with the consensus rating category and save that data for later use.

If no consensus is reached after the crowdsourcing users have provided their ratings, the visual content labeling system can discard the visual content or use a plurality of machine-learned models to generate a label for the image and/or video. In general, labels generated by machine-learning models can be less reliable than labels generated by the above-described labeling system. Once the labels have been stored for the plurality of images and/or video, this data can be stored in a database for training image labeling models. This data can be referred to as a golden dataset.

In some examples, the machine-learned models can include a plurality of large language models. Each model in the plurality of large language models can be trained separately and may be trained on a different corpus of data. The visual content labeling system 142 can use the plurality of large language models to provide labels for images with respect to particular subjective attributes. For example, the labeling system can generate input for a plurality of different large language models. Each large language model can be trained separately and have different internal weights and values. The input for each model can be customized such that it is correctly formatted for the particular large language model for which it is intended. For example, the input can include one or more images to be rated, the subjective attribute to be rated, and a prompt requesting a rating for each images and/or video.

Each large language model (LLM) can output a rating for each image or video. The rating can include the specific rating category that the LLM associated with the image (e.g., a rating category from “highly relevant” to “highly nonrelevant”) and a confidence value associated with the rating. The plurality of ratings from the different large language models can be compared to determine whether they reach a consensus rating category. For example, this consensus can be based on the agreement between the different ratings and/or the agreement between the confidence of the various rating categories. Thus, if all the ratings have the same rating category, but the confidence is low from the different large language models, the visual content labeling system 142 may determine that the consensus has not been reached. Conversely, if not all of the ratings match, but the ratings that do match all have a very high confidence, and only one outlier differs and has low confidence, the visual content labeling system 142 may determine that a consensus has been reached.

All images and videos that have received labels based on a consensus of the multiple large language models can be stored, along with their respective labels, as training data. This training data can be used to train machine-learned models that generate labels for images and/or videos. In some examples, this initial training data can be used to train a machine-learned model and the golden data set (generated using human-labeled visual content as described above) can be used to validate or improve the model.

In some examples, the large language model can be trained by a training system to accurately classify images based on a subjective attribute. To do so, the training system can obtain a plurality of rules for evaluating images. Based on the rules, the training system can generate fuzzy conditions for evaluating characteristics of an image. The image classification model can receive training data as input. The training data can also be provided to a classifier that implements the fuzzy conditions. The image classification model can output a classification for the training data. The training system can identify a loss value by comparing the output classifications from the model and the classification indicated by the fuzzy conditions. One or more values of the model can be updated based on the difference. This can be repeated until the loss value between the model and the rules classification reaches an acceptable level.

In some examples, the accessed rules can be predetermined rules for image interpretation generated by experts. Generating the fuzzy conditions can include extracting linguistic conditions from the rules. The fuzzy conditions can be used by the training system to identify potential inputs (e.g., image characteristics) and their fuzzy membership regions. The training system can use the inputs and their fuzzy membership regions to generate if-then statements. The process for generating fuzzy conditions can include eliminating contradictory rules.

In some examples, the system can assign an importance to each fuzzy condition. The system can generate a loss value based on a fuzzy rule contradiction loss. The system can generate a loss value based on a fuzzy interference loss. The system can update the one or more values of the model using backpropagation.

In some examples, particular subjective attributes are very rare. For example, very few images (or videos) may qualify to be classified as “romantic.” As a result, using human raters to sort through thousands of images when only a tiny percentage of those images will match the qualifications is exceptionally inefficient. One way to improve this effectiveness is initially to use multiple large language models to get ratings for many images or videos automatically. The visual content labeling system 142 can identify a subset of the large corpus of images that reach a threshold of being associated with a romantic label.

Once this smaller subset of images has been identified, the visual content labeling system 142 can use the human labeling system described above to clarify which is associated with the subject attribute.

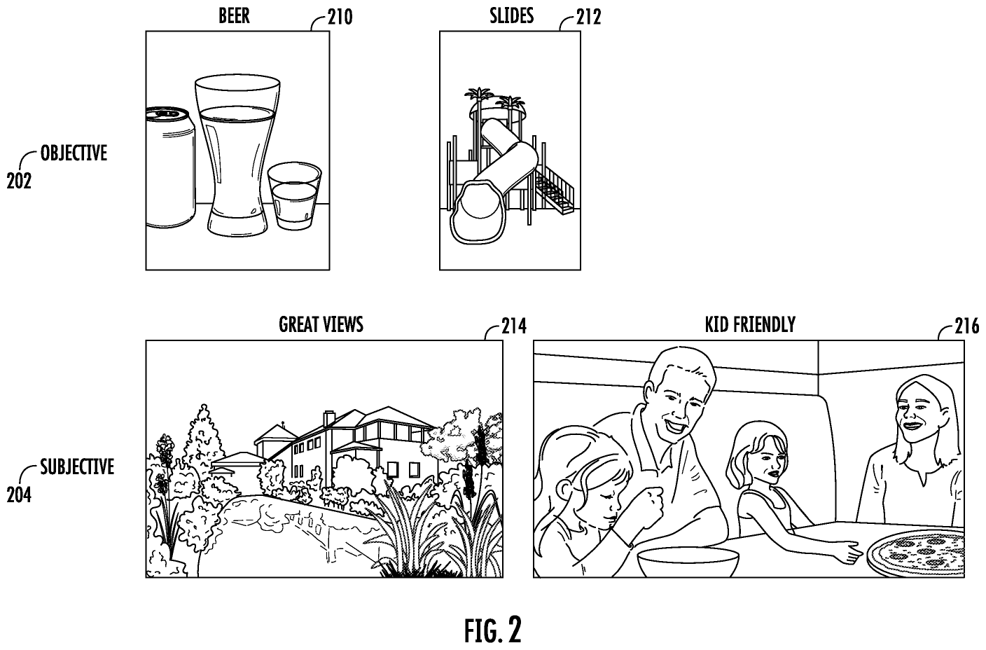

FIG. 2 illustrates an example of objective and subjective attributes according to some embodiments of the present disclosure. The images in this figure give examples of images that are relevant to either objective attributes 202 or subjective attributes 204. As seen in this example, objective attributes 202 can be clearly identified by the presence or absence of particular objects in the image. “Beer” and Slides” are both examples of objective attributes 202. Image 210 includes a glass of beer and can be determined to be relevant to the “Beer” label with high confidence. Similarly, image 212 includes a slide and can be determined to be relevant to the “Slides” label with high confidence.

Subjective attributes are attributes that are not associated with the presence of one specific object or feature of an image. In this example, the “Great views” and the “Kid-friendly” labels are examples of subjective attributes 204. Image 214 includes a plurality of features that, when considered together, can be determined to be relevant to the “great views” label. Similarly, image 216 can include features that can be determined to be relevant to the “kid-friendly” label.

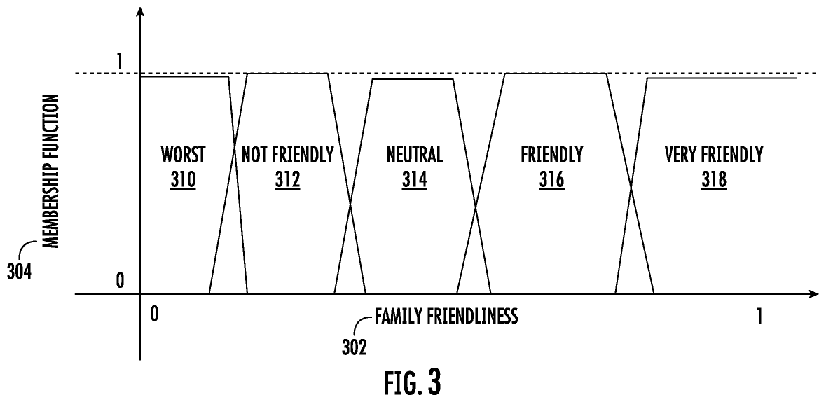

FIG. 3 illustrates an example of rating categories for a particular subjective attribute according to some embodiments of the present disclosure. In this example, the rating for “family friendliness” is represented on a graph that represents, on the x-axis, the rating categories of the image with respect to “family friendliness” 302 and, on the y-axis, the confidence 304 of that rating. If the rating is represented as a value between 0 and 1, the numerical rating can be grouped into five different rating categories.

The rating categories can be “very friendly” 318, “friendly” 316, “neutral” 314, “not friendly” 312, and “very not friendly” 310. A rating user can select a rating category directly from a list or can use a value between 0 and 1 and that value can be grouped into a category. The confidence is also a value between 0 and 1, with 0 representing no confidence and 1 representing certainty.

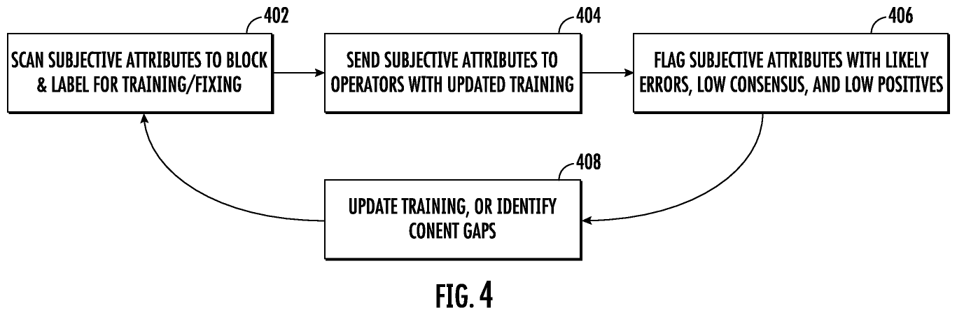

FIG. 4 illustrates an example flow for identified subjective attributes (topics) to be used as labels for visual content according to some embodiments of the present disclosure. In this example, a computing system (e.g., the visual content labeling system 142 of FIG. 1) can evaluate, at 402, the plurality of potential subjective attributes (or topics). For each subjective topic, the computing system can determine whether the subjective attribute is applicable for labeling and whether sufficient number of positives examples have already been identified.

In some examples, some subjective attributes are associated with topics that cannot be labeled, such as inappropriate subject matter, biased or harmful issues, and information for which searches will not be performed. These subjective attributes can be blocked from the standard labeling and training cycle.

Once the subjective attributes (topics) are determined to be of interest and not blocked or identified, the visual content labeling system 142 can, at 406, transmit the subjective attributes to rating users (operators) along with potential images that may be labeled with that subjective attribute. Based on the ratings received from the rating users, the labeling system can, at 406, flag subjective attributes with low consensus and/or low positive examples. The system can also flag subjective attributes that likely have errors in the labeling.

For the subjective attitudes determined to have likely errors, low confidence, or low positives, the visual content labeling system 142 can, at 408, update the training associated with the ratings to provide more consistency with consensus and reduce errors, as well as identify potential images that may be positive examples.

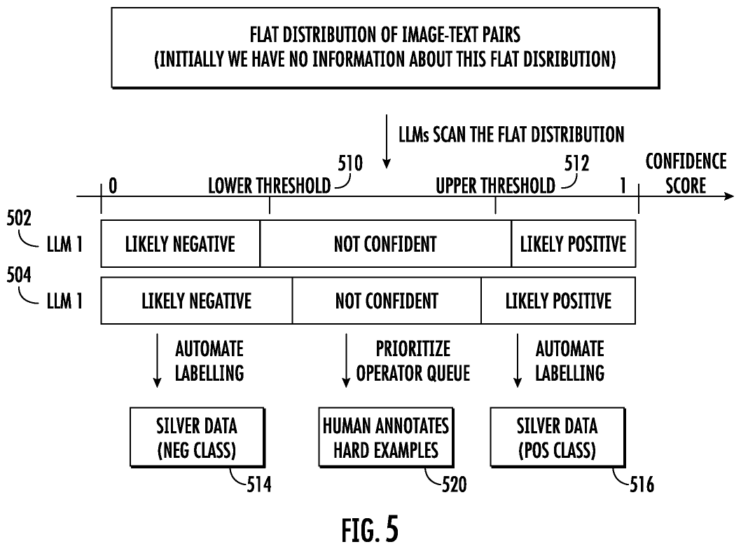

FIG. 5 illustrates an example of ratings produced by large language models and how those ratings are interpreted according to some embodiments of the present disclosure. For example, input can be provided to a plurality of large language models (e.g., LLM1 502 and LLM2 504). In some examples, each large language model can output a rating and confidence score for each image with respect to particular subjective attributes.

The radius could be a value between zero and one. The visual content labeling system can have a predefined lower threshold 510 and a predefined upper threshold 512. Images for which the rating score is below the lower threshold 510 can be grouped into the negative class 514 of examples. Images in the negative class 514 can automatically be labeled as not being associated with the subject.

Similarly, images (or videos) with a rating score above the upper threshold 512 can be grouped into the positive class 516. Images (or videos) in the positive class 516 can be labeled with the subjective attribute. Images (or videos) with a rating below the upper threshold by one but above the upper threshold 512 can be determined to be complex examples 520. These can be sent to human operators to annotate. The images labeled by the output of multiple LLMS can be referred to as the silver dataset. The silver dataset can be used to train a visual content labeling model initially. The golden dataset discussed above can be used to validate or further train the image labeling model.

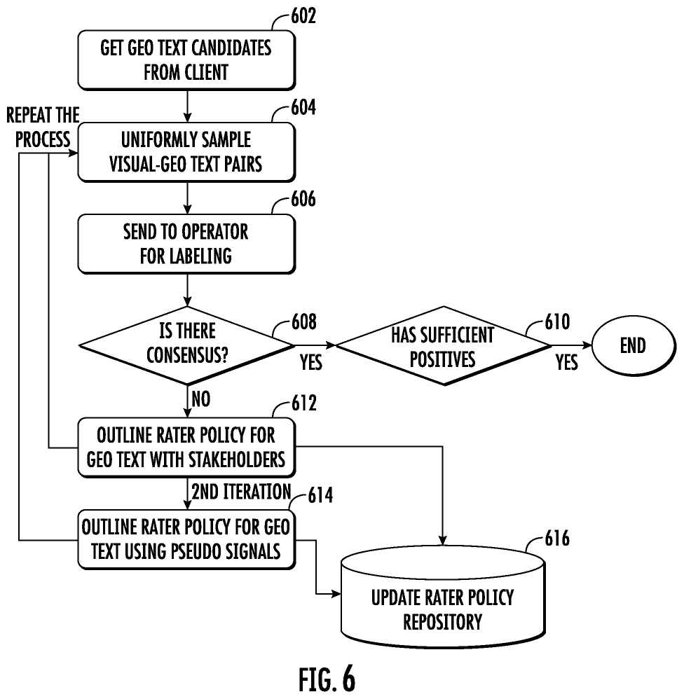

FIG. 6 illustrates an example of ratings produced by large language models according to some embodiments of the present disclosure. In some examples, the visual content labeling system can, at 602, access a plurality of candidate subjective attributes. The visual content labeling system can, at 604, then uniformly sample the visual geo-text pairs for the plurality of candidate subjective attributes. Visual geo-text pairs can be an image pair with a particular subjective attribute or other description. The system can transmit, at 606, one or more images and one or more subjective attributes to a rating user (or operator).

The subjective attribute labeling system can receive, from the rating users, a plurality of ratings for each image. For a particular image (and a particular subjective attribute), the system can determine whether there is a consensus at 608. If there is consensus, the visual content labeling system can determine, at 610, whether there are sufficient positive examples for a particular subjective attribute. A positive example of a subjective attribute is any image or video that reaches consensus with a rating that the subjective attribute is associated with the image or video. Positive labels can be labeled with the subjective attribute. A negative example can be a video or image that has reached a rating consensus indicating that the subjective attribute is not associated with the video or image. If there are sufficient positive examples, the visual content labeling system can cease to request ratings for the particular subjective attribute. If not, the system can continue to request ratings of images and videos with respect to the subjective attribute.

If no consensus is reached, the system can, at 612, outline, revise, or improve the rating policy for the specific subjective attribute (e.g., geotext). In some examples, once the rating policy has been outlined, revised, or improved, the visual content rating system can repeat the rating process described above. Once the rating policy has been outlined, revised, or improved once, the visual content labeling system can, at 614, outline reader policy for geo-text using pseudo signals. Pseudo-signals can include a plurality of signals that can be used to evaluate subjective attribute rating policies. The attribute rating policy can be stored in the updated rating policy repository 616.

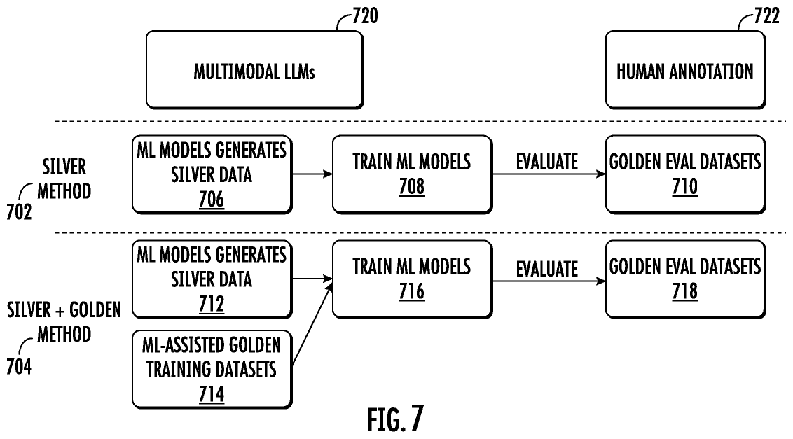

FIG. 7 illustrates examples of methods of using labeled data to train machine-learned models according to some embodiments of the present disclosure. The figure represents two possible examples of using labeled data to train a machine-learned model. Some steps in the examples can be performed by LLMS 720 and some steps can be accomplished by human annotation 722. The first method is called the silver method 702. The silver method uses multiple large language models to generate label data for plotting images. If there is significant agreement between the various models, the images can be labeled according to the output of the models. The label data generated by this process can be called the silver data 706. This silver data can be used, at 708, to train a machine-learned model. The human-annotated golden dataset 710 (by a method described above in which humans label the data until consensus is formed) can be used to evaluate the machine learning model and adjust its parameters.

The second example method is the silver and gold method 704. In the silver and gold method 704, machine-learned models are used, at 712, to generate labels for images and videos. A golden dataset is generated, at 714, in which high-quality labels are applied to images based on consensus among the rating users. The golden and silver datasets can be used to train the model at 716. The golden dataset 718, or a portion thereof, can be used to evaluate the machine-learned models and adjust parameters as needed.

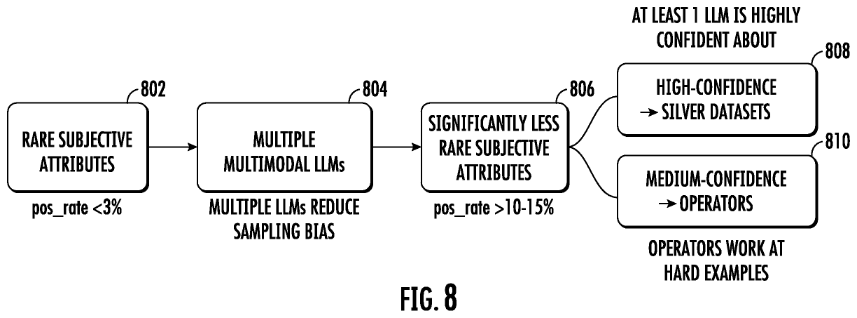

FIG. 8 illustrates an example method for improving the efficiency of labeling rare topics according to some embodiments of the present disclosure. In some examples, particular subjective attributes are rare, so it is challenging to find positive examples in images or videos. Rare subjective attributes 802 can be defined as when less than 3% of images evaluated for this label are positive examples of the attribute. Using human labelers to evaluate these images is highly inefficient and may also have accuracy.

One method to improve the accuracy and efficiency of labeling these rare attributes can include initially using, at 804, multiple large language models to generate ratings for each image or video that is a potential candidate to have the rare label applied. Based on the ratings from the multiple LLMs, the total possible set of images and videos can be altered to remove images and videos that are unlikely to be associated with the rare attribute. Once these bad candidates have been removed, the remaining images and videos are significantly more likely to be associated with the label. For example, suppose 80% of images are removed from the video and image set. In that case, the likelihood of a particular remaining video or image being labeled with the subjective attribute can increase from 3% to above 10%.

Once the data set has been narrowed, at 806, the visual content labeling system can identify images that at least one LLM rates as highly associated with the subjective attribute. These high-confidence images can automatically be labeled based on the associated subjective attribute and stored in a high confidence dataset 808 for other machine-labeled images. This dataset can be referred to as the silver data set. Any images that have medium confidence can be transmitted, at 810, to a plurality of rating users for rating. Because the images have been filtered, the likelihood of identifying a positive is significantly increased, and the efficiency of manual rating is improved.

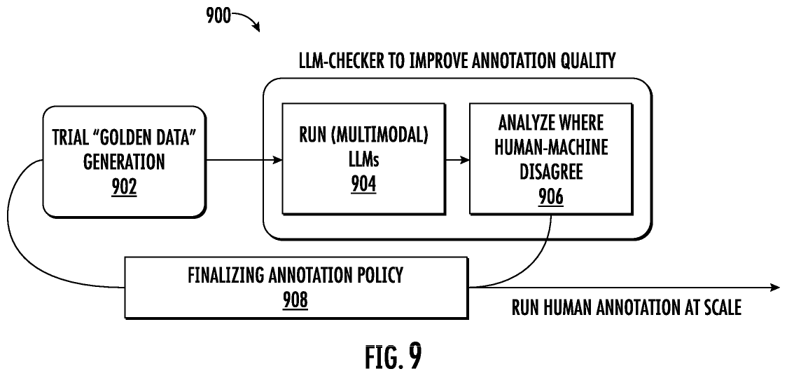

FIG. 9 illustrates an example method for improving the accuracy of the golden dataset generation system according to some embodiments of the present disclosure. In this example, the golden dataset generation system can be used, at 902, to generate labels for a plurality of images and/or videos.

In some examples, a large language model checker 900 can be used to identify potential problems with the golden dataset annotation system. For example, once the trial dataset of labels have been gathered, the large language model checker 900 can run multiple machine-learned models (LLMs), at 904, to generate labels for the images (or videos) in the golden dataset. The large language model checker 900 can analyze both the labels generated by the multiple LLMs, and the labels are rated by the rating users to identify, at 906, instances of which the LLM-generated labels and the human labels disagree.

The large language model checker 900 can analyze any disagreements between the labels generated by the LLMS and the labels produced by the labeling trial. Based on that analysis, the large language model checker 900 can, at 908, generate a final annotation policy for instructing rating users on how to rate images based on subjective attributes properly. The updated annotation policy can be stored in a database and provided to rating users (e.g., operators) as necessary during the golden data set generation process.

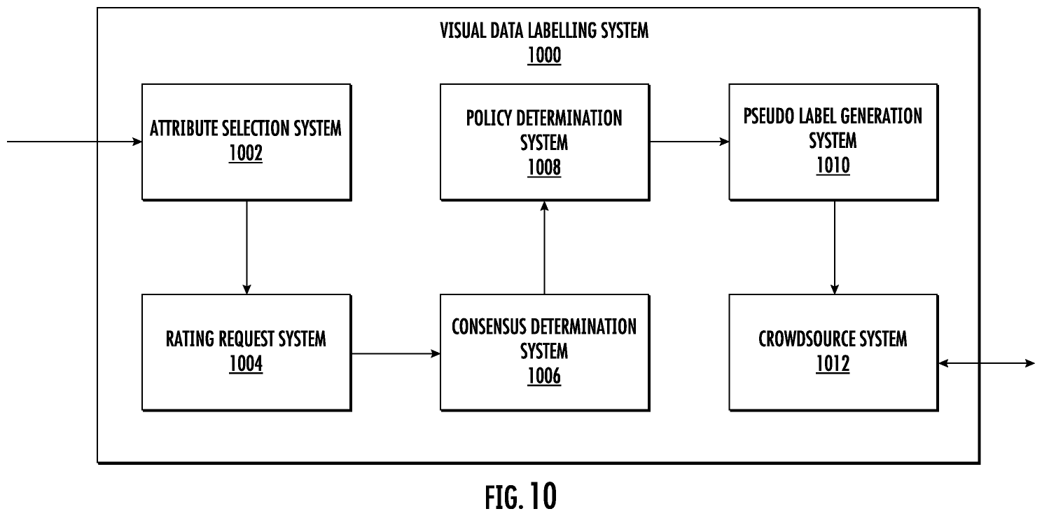

FIG. 10 depicts a block diagram of a visual content labeling system 1000 that performs according to example embodiments of the present disclosure. The visual content labeling system 1000 can be a server computing device. The visual data labeling system can include an attribute selection system 1002, a rating request system 1004, a consensus determination system 1006, a policy determination system 1008, a pseudo-label generation system 1010, and a crowdsource system 1012.

The attribute selection system 1002 can determine specific subjective attributes for which labeled visual content is requested. Specific subjective attributes may be excluded for suitability reasons or to exclude offensive content. Once the subjective attributes have been selected, the rating request system 1004 can transmit a plurality of pieces of visual content, including images and videos, to a first plurality of rating users along with this subjective attribute and one or more rating categories. The visual content labeling system 1000 can receive ratings from the rating users. The visual data labeling system 1000 can determine whether a consensus has been reached using consensus determination system 1006.

The consensus determination system 1006 can determine whether there is a similarity between the ratings such that all the ratings have selected the same rating category or at least a certain percentage have selected the same rating category. The images/videos and their associated labels can be stored if the consensus determination system 1006 had determined that a consensus has been reached. If no consensus has been reached, the policies for rating the images and videos can be updated by the policy determination system 1008. In addition, the pseudo-label generation system 1010 can generate a plurality of pseudo-labels.

In some examples, the rating request system 1004 can request new ratings each time the policy is updated or the pseudo-label generation system 1010 generates pseudo-labels. The consensus determination system 1006 can receive ratings from users, determine whether a consensus has been reached, and, if not, take additional steps to improve the chance that consensus may be reached. The crowdsource system 1012 can select users from a pool of diverse users who have not previously rated these images or videos. Those users can be selected randomly (or pseudo-randomly) so that no bias is introduced by location, culture, language, and so on. The crowdsource system 1012 can receive class crowdsourced ratings from a plurality, and the consensus determination system 1006 can determine whether constraints are needed.

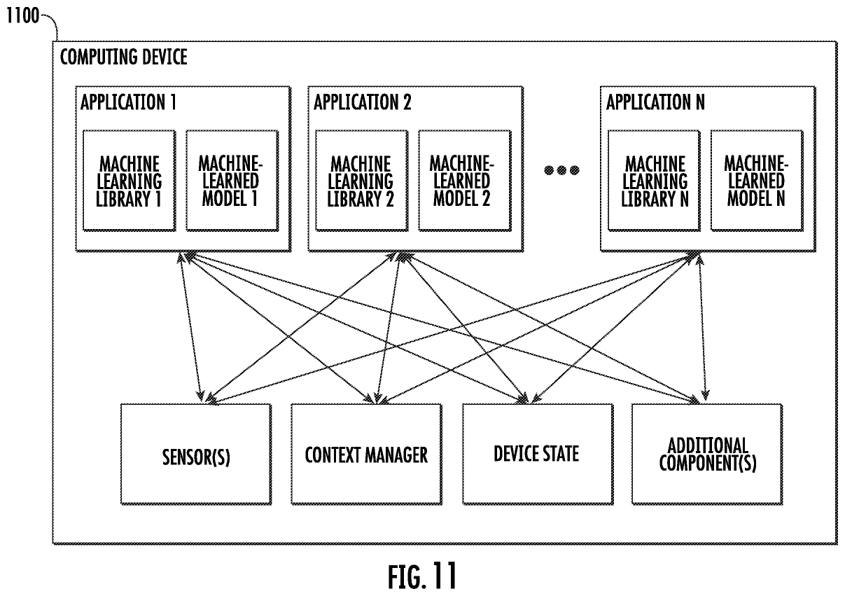

FIG. 11 depicts a block diagram of an example computing device 1100 that performs according to example embodiments of the present disclosure. The computing device 1100 can be a user computing device or a server computing device.

The computing device 1100 includes a number of applications (e.g., applications 1 through N). Each application contains its own machine-learned library and machine-learned model(s). For example, each application can include a machine-learned model. Example applications include a data transmission application, a rating reception application, a consensus determination application, a pseudo-label generation application, a crowdsourcing application, a model training application, a search response application, etc.

As illustrated in FIG. 11, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

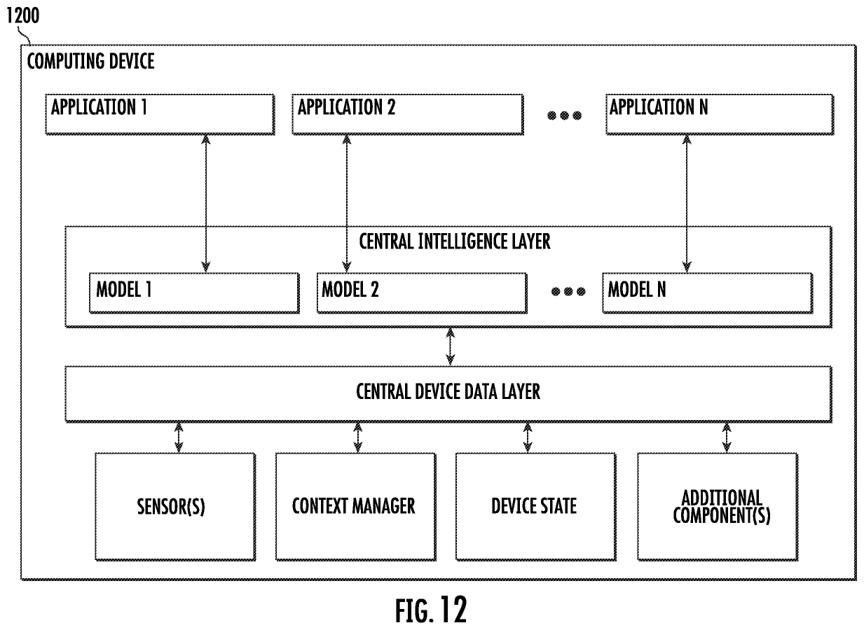

FIG. 12 depicts a block diagram of an example computing device 1200 that performs according to example embodiments of the present disclosure. The computing device 1200 can be a user computing device or a server computing device.

The computing device 1200 includes a number of applications (e.g., applications 1 through N). Each application is in communication with a central intelligence layer. Example applications include a data transmission application, a rating reception application, a consensus determination application, a pseudo-label generation application, a crowdsourcing application, a model training application, a search response application, etc. In some implementations, each application can communicate with the central intelligence layer (and model(s) stored therein) using an API (e.g., a common API across all applications).

The central intelligence layer includes a number of machine-learned models. For example, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device.

The central intelligence layer can communicate with a central device data layer. The central device data layer can be a centralized repository of data for the computing device 1200. As illustrated in FIG. 12, the central device data layer can communicate with a number of other components of the computing device, such as, for example, one or more sensors, a context manager, a device state component, and/or additional components. In some implementations, the central device data layer can communicate with each device component using an API (e.g., a private API).

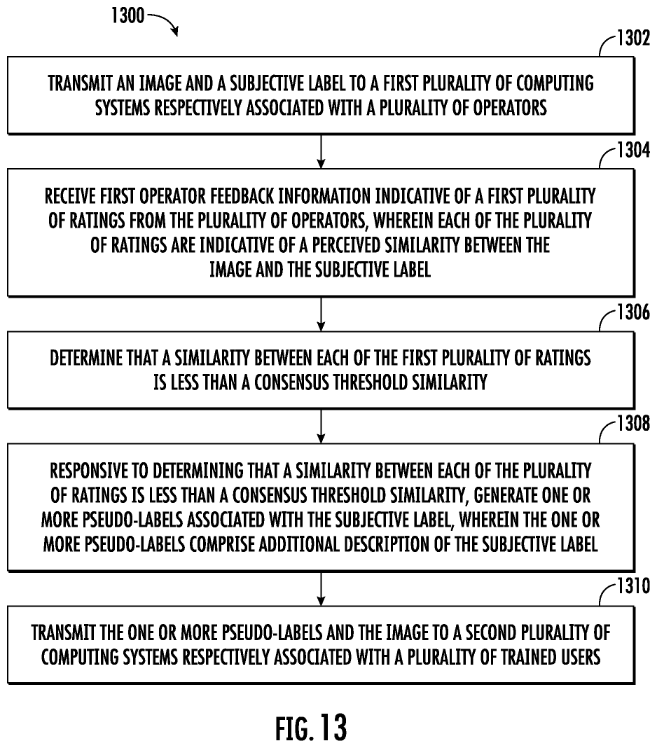

FIG. 13 depicts an example flow diagram 1300 for a method of accurately providing labels for visual content according to example embodiments of the present disclosure. One or more portion(s) of the method can be implemented by one or more computing devices such as, for example, the computing devices described herein. Moreover, one or more portion(s) of the method can be implemented as an algorithm on the hardware components of the device(s) described herein. FIG. 13 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. The method can be implemented by one or more computing devices, such as one or more of the computing devices depicted in FIGS. 1 and 10.

A computer system can include one or more processors, memory, and one or more communication components. The computer system can include other components that, together, enable the computer system to access the one or more pieces of visual content from a database of visual content associated with locations and the subjective attribute from a list of subjective attributes of interest.

The computing system can, at 1302, transmit a piece of visual content and a subjective attribute to a first plurality of computing systems respectively associated with a plurality of operators. In some examples, the computing system transmits the piece of visual content and the subjective attribute to a fourth plurality of computing systems respectively associated with untrained operators without a rating policy.

The computing system can receive third operator feedback information indicative of a third plurality of ratings from the plurality of operators. The computing system can determine that a similarity between each of the third plurality of ratings is less than a consensus threshold similarity. In response to determining that a similarity between each of the third plurality of ratings is less than a consensus threshold similarity, the operating system can access a rating policy for the subjective attribute.

The computing system can transmit the piece of visual content, the subjective attribute, and the rating policy to a fifth plurality of computing systems respectively associated with operators. The computing system can request ratings for the piece of visual content based on the rating policy.

In some examples, the computing system can, at 1304, receive first operator feedback information indicative of a first plurality of ratings from the plurality of operators, wherein each of the plurality of ratings indicates a perceived similarity between the piece of visual content and the subjective attribute. In some examples, the ratings represent the degree to which the subjective attribute applies to the piece of visual content.

In some examples, the system can, at 1306, determine that a similarity between each of the first plurality of ratings is less than a consensus threshold similarity. The computing system can, in accordance with a determination that a similarity between each of the first plurality of ratings exceeds the consensus threshold similarity, store a label for the piece of visual content based on the similarity between each of the first plurality of ratings. In some examples, the label is indicative of a respective rating category associated with the piece of visual content.

In some examples, the computing system can, at 1308 and responsive to determining that a similarity between each of the plurality of ratings is less than a consensus threshold similarity, generate one or more pseudo-labels associated with the subjective attribute, wherein the one or more pseudo-labels comprise additional description of the subjective attribute. In some examples, the ratings include categorizing the piece of visual content into one of a plurality of rating categories, each representing a degree to which the subjective attribute applies to the piece of visual content.

The computing system can determine a rating category for each rating received from the first plurality of computing systems associated with a plurality of operators. The computing system can determine, for each respective rating category, a percentage of the plurality of operators that have selected the respective rating category to be associated with the piece of visual content. The computing system can determine whether the percentage of operators for any rating category exceeds a predetermined threshold percentage.

In response to determining that none of the rating categories have a percentage of operators that exceed the predetermined threshold percentage, the computing system can determine that a similarity between each of the first plurality of ratings is less than a consensus threshold similarity. In some examples, the pseudo-labels are selected to be more descriptive than the original subjective attribute. In some examples, the pseudo-labels can be selected automatically. For example, the pseudo-labels can be selected based on an output of a machine-learned model using the original subjective attribute as input.

The computing system can, at 1310, transmit the one or more pseudo-labels and the piece of visual content to a second plurality of computing systems associated with a plurality of trained users. In some examples, the computing system can receive, from the second plurality of computing systems, second operator feedback information indicative of a second plurality of ratings from the plurality of operators. The computing system can determine that a similarity between each of the second plurality of ratings is less than a consensus threshold similarity. The computing system can transmit the piece of visual content and the one or more pseudo-labels to a third plurality of computing systems respectively associated with a plurality of community users. In some examples, the plurality of community users can be crowdsourced from a pool of users.

In some examples, the computing system can generate a plurality of labels for a plurality of pieces of visual content. The computing system can store the plurality of generated labels and the associated pieces of visual content. The computing system can train a semantic visual content classifier using the plurality of pieces of visual content and labels as ground truth.

In some examples, the computing system can, prior to training a semantic visual content classifier using the plurality of pieces of visual content and labels as ground truth, determine whether there are a sufficient number of positive examples based on the stored labels for each subjective attribute.

In some examples, in accordance with a determination that there is an insufficient number of positive examples of a particular subjective attribute, the computing system can generate input for a plurality of machine-learned models, wherein the input includes a plurality of pieces of visual content, a subjective attribute, and a prompt requesting a rating of the plurality of pieces of visual content with respect to the subjective attribute.

In some examples, the computing system can receive a labeled data set as output from each model in the plurality of machine-learned models. The labeled data set from each machine-learned model can include a rating for each piece of visual content and a confidence value for the rating. The computing system can combine the labeled data sets from each model into a plurality of labels for the plurality of pieces of visual content.

In some examples, the computing system can train a geo-semantic labeling model based on the plurality of labels for the plurality of pieces of visual content. In some examples, the computing system can validate the geo-semantic labeling model using the plurality of generated labels and the associated pieces of visual content. In some examples, the input can be a prompt for a large-language model. In some examples, the computing system can generate a customized prompt for each large-language model in the plurality of machine-learned models.

In some examples, the computing system can determine whether a consensus label exists for each piece of visual content. In accordance with a determination that a consensus label does not exist for a particular piece of visual content, the computing system can request a rating from an operator.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system, the system comprising:
one or more processors; and
one or more non-transitory computer-readable media that collectively store instructions that, when executed by the one or more processors, cause the computing system to perform operations, the operations comprising:
transmitting a piece of visual content and a subjective attribute to a first plurality of computing systems respectively associated with a plurality of operators;
receiving first operator feedback information indicative of a first plurality of ratings from the plurality of operators, wherein each of the plurality of ratings are indicative of a perceived similarity between the piece of visual content and the subjective attribute;
determining that a similarity between each of the first plurality of ratings is less than a consensus threshold similarity;
responsive to determining that a similarity between each of the plurality of ratings is less than a consensus threshold similarity, generating one or more pseudo-labels associated with the subjective attribute, wherein the one or more pseudo-labels comprise additional description of the subjective attribute; and
transmitting the one or more pseudo-labels and the piece of visual content to a second plurality of computing systems respectively associated with a plurality of trained users.

2. The computing system of claim 1, the operations further comprising:
receiving, from the second plurality of computing systems, second operator feedback information indicative of a second plurality of ratings from the plurality of operators;
determining that a similarity between each of the second plurality of ratings is less than a consensus threshold similarity; and
transmitting the piece of visual content and the one or more pseudo-labels to a third plurality of computing systems respectively associated with a plurality of community users.

3. The computer system of claim 1, the operations further comprising:
accessing the one or more pieces of visual content from a database of visual content associated with locations and the subjective attribute from a list of subjective attributes of interest.

4. The computer system of claim 1, wherein transmitting the piece of visual content and the subjective attribute to a first plurality of computing systems respectively associated with a plurality of operators further comprises:
transmitting the piece of visual content and the subjective attribute to a fourth plurality of computing systems respectively associated with untrained operators without a rating policy.

5. The computing system of claim 4, wherein transmitting the piece of visual content and the subjective attribute to a first plurality of computing systems respectively associated with a plurality of operators further comprises:
receiving third operator feedback information indicative of a third plurality of ratings from the plurality of operators;
determining that a similarity between each of the third plurality of ratings is less than a consensus threshold similarity;
in response to determining that a similarity between each of the third plurality of ratings is less than a consensus threshold similarity, accessing a rating policy for the subjective attribute;
transmitting the piece of visual content, the subjective attribute, and the rating policy to a fifth plurality of computing systems respectively associated with operators; and
requesting ratings for the piece of visual content based on the rating policy.

6. The computing system of claim 1, wherein the ratings include a categorization of the piece of visual content into one of a plurality of rating categories, each rating category representing a degree to which the subjective attribute applies to the piece of visual content.

7. The computing system of claim 6, wherein determining that a similarity between each of the first plurality of ratings is less than a consensus threshold similarity further comprises:
determining a rating category for each rating received from the first plurality of computing systems respectively associated with a plurality of operators;
determining, for each respective rating category, a percentage of the plurality of operators that have selected the respective rating category to be associated with the piece of visual content;
determining whether the percentage of operators for any rating category exceeds a predetermined threshold percentage; and
in response to determining that none of the rating categories have a percentage of operators that exceed the predetermined threshold percentage, determining that a similarity between each of the first plurality of ratings is less than a consensus threshold similarity.

8. The computing system of claim 1, wherein the pseudo-labels are selected to include one or more objective factors for use in rating with respective to the subjective attribute.

9. The computing system of claim 1, wherein the pseudo-labels are selected automatically.

10. The computing system of claim 9, wherein the pseudo-labels are selected based on an output of a machine-learned model using the original subjective attribute as input.

11. The computing system of claim 1, the operations further comprising:
in accordance with a determination that a similarity between each of the first plurality of ratings exceeds the consensus threshold similarity, storing a label for the piece of visual content based on the similarity between each of the first plurality of ratings.

12. The computing system of claim 11, wherein the label is indicative of a respective rating category associated with the piece of visual content.

13. The computing system of claim 12, the operations further comprising:
generating a plurality of labels for a plurality of pieces of visual content;
storing the plurality of generated labels and the associated pieces of visual content; and
training a semantic visual content classifier using the plurality of pieces of visual content and labels as ground truth.

14. The computing system of claim 13, the operations further comprising:
prior to training a semantic visual content classifier using the plurality of pieces of visual content and labels as ground truth, determining whether there are a sufficient number of positive examples based on the stored labels for each subjective attributes.

15. The computing system of claim 14, the operations further comprising:
in accordance with a determination that there are insufficient number of positive examples of a particular subjective attribute:
generating input for a plurality of machine-learned models, wherein the input includes a plurality of pieces of visual content, a subjective attribute, and a prompt requesting a rating of the plurality of pieces of visual content with respect to the subjective attribute;
receiving a labeled data set as output from each model in the plurality of machine-learned models, the labeled data set from each machine-learned model including a rating for each piece of visual content and a confidence value for the rating;
combining the labeled data sets from each model into a plurality of labels for the plurality of pieces of visual content;
training a geo-semantic labeling model based on the plurality of labels for the plurality of pieces of visual content; and
validating the geo-semantic labeling model using the plurality of generated labels and the associated pieces of visual content.

16. The computing system of claim 15, wherein the input is a prompt for a large-language model.

17. The computing system of claim 16, the operations further comprising:
generating a customized prompt for each large-language model in the plurality of machine-learned models.

18. The computing system of claim 17, wherein combining the labeled data sets from each model into a plurality of labels for the plurality of piece of visual contents comprises:
determining whether a consensus label exists for each piece of visual content; and
in accordance with a determination that a consensus label does not exist for a particular piece of visual content, request a rating from an operator.

19. A computer-implemented method for efficiently rating visual content with respect to subjective attributes, the method comprising:
transmitting a piece of visual content and a subjective attribute to a first plurality of computing systems respectively associated with a plurality of operators;
receiving first operator feedback information indicative of a first plurality of ratings from the plurality of operators, wherein each of the plurality of ratings are indicative of a perceived similarity between the piece of visual content and the subjective attribute;
determining that a similarity between each of the first plurality of ratings is less than a consensus threshold similarity;
responsive to determining that a similarity between each of the plurality of ratings is less than a consensus threshold similarity, generating one or more pseudo-labels associated with the subjective attribute, wherein the one or more pseudo-labels comprise additional description of the subjective attribute; and
transmitting the one or more pseudo-labels and the piece of visual content to a second plurality of computing systems respectively associated with a plurality of trained users.

20. A non-transitory computer-readable medium storing instructions that, when executed by one or more computing devices, cause the one or more computing devices to perform operations, the operations comprising:
transmitting a piece of visual content and a subjective attribute to a first plurality of computing systems respectively associated with a plurality of operators;
receiving first operator feedback information indicative of a first plurality of ratings from the plurality of operators, wherein each of the plurality of ratings are indicative of a perceived similarity between the piece of visual content and the subjective attribute;
determining that a similarity between each of the first plurality of ratings is less than a consensus threshold similarity;
responsive to determining that a similarity between each of the plurality of ratings is less than a consensus threshold similarity, generating one or more pseudo-labels associated with the subjective attribute, wherein the one or more pseudo-labels comprise additional description of the subjective attribute; and
transmitting the one or more pseudo-labels and the piece of visual content to a second plurality of computing systems respectively associated with a plurality of trained users.
